(19) United States
(12) Patent Application Publication
(10) Pub. No.: US 2002/0092218 A1
(43) Pub. Date: Jul. 18, 2002

(54) Sports advertising nets

(76) Inventor: David Black, Atlanta, GA (US)

Correspondence Address: Charles Lee Thomason, Frost Brown Todd LLC, 32nd Floor, 400 West Market Street, Louisvile, KY, 40202, US

(21) Appl. No.: 10/050,479

(22) Filed: Jan. 15, 2002

Related U.S. Application Data
(60) Provisional application No. 60/262,239, filed on Jan. 16, 2001.

(51) Int. Cl. G09F 17/00

(52) U.S. Cl. 40/603

(57) ABSTRACT

Nets are used in a variety of applications, including sports, mainly for protection. The present invention provides a method and apparatus for manufacturing nets which are imprinted with text or graphics on one or both sides. These nets serve the dual purpose of protection and advertising, without requiring any sort of appurtenance. The nets typically comprise single or multiple pieces of netting, engineered to fit the application, and are made of nylon or polynylon woven into a mesh configuration without standard knots. The front and/or back surface area of the net is printable with graphic or text messages by way of digital printing, silk screen, air brush painting, roller painting, airless spray painting, aerosol spray painting, dyeing, and other methods. The nets are placed on a platen having paraffin or similar substance, and then the imprinting is made. The paraffin prohibits or impedes the imprinted material from getting unintentionally transferred to the opposite side of the net.

### CROSS-REFERENCE TO RELATED APPLICATIONS

The applicant claims the benefit of the prior filed and pending provisional application, that was filed Jan. 16, 2001 and given application Ser. No. 60/262,239.

### STATEMENT REGARDING FEDERALLY SPONSORED RESEARCH OR DEVELOPMENT

Not applicable

### BACKGROUND OF THE INVENTION

This invention relates generally to nets and to means for displaying information without obstructing the view through said displaying means.

The system described herein is deemed applicable to nets of various sizes, shapes, uses, and locations. For instance, nets are commonly used in sports venues, industrial applications (such as warehousing, cargo, shipping, manufacturing, etc.), recreation applications (such as parks, residential uses, etc.), and many other locations and uses. For the sake of brevity herein, the nets to which the invention is directed will be discussed in the context of sporting venues.

Sports venues today, including but not limited to baseball, football, soccer, rugby, track & field, lacrosse, as well as others, typically utilize nets as some form of protection. Most commonly, nets are used to protect spectators from interfering with, or being affected by, the action taking place on the field. Perhaps the most recognizable example of such nets are the nets used to prevent a football that has been kicked through a goal post from striking spectators in the stand. Sometimes such nets are permanently mounted behind the goal post area. For example, in collegiate, high school, and other non-professional leagues, the net is usually a permanent fixture. Other times the nets are mounted such that they can be raised and lowered whenever needed during the action on the field. For example, in professional football franchises and other well-funded leagues, the net is mounted such that it can be raised when a kicked football is expected through the goal posts, and lowered when no such expectation exists. Nets in use today for most applications typically are “cord type” nets that contain a pattern of knots at the comers or endpoints of each mesh opening.

With continually decreased funding for non-professional athletic events, and everrising costs associated therewith, schools and other organizations often turn to advertising to raise much-needed revenue to support athletic programs. Organizations have varying methods for raising revenue via advertising. Often sponsorships are sought for team uniforms, event programs, event announcements, and advertising space. Perhaps the prime example of advertising space associated with non-professional athletic venues occur in baseball and softball fields. Frequently, the fences of these fields are solid boards on which advertising space is available for a fee. Other types of advertising means used in these arenas include rotating signage, signs containing electrical lighting and associated appurtenances (light bulbs, mounting brackets, gaskets, frames, back panels, electrical wiring, and electrical controls). Because of the expense, maintenance, and size of such alternative advertising means, organizations are always looking for effective, alternative advertising space.

Devices have attempted to solve the need for such alternative advertising at sporting arenas, but such devices have not adequately succeeded. For instance, Rodriguez, U.S. Pat. No. 5,280,904 describes an electrical structure that can be physically attached to the exterior of a net that can provide an illuminated message. Though helpful, this device has not proved satisfactory for many reasons, including the fact that the device is expensive and cumbersome, and the fact that many organizations (including the NFL, CFL, WFL, AFL, NCAA, and most high school athletic associations, as well as other organizations) have rules prohibiting the attachment of physical items, including nets, to goal posts.

The need for effective advertising space exists, in part, because of a lack of viable means of projecting advertising images onto existing surfaces. For instance, as stated above, protective nets are typically located in extremely high-visibility areas that are in prime locations for potentially generating income from advertising. Protective nets at sporting venues are frequently highly visible to spectators, passers-by, and broadcast equipment. However, the cord type nets typically used are used only for protection, not for advertising. One reason for this is that these nets, with their pattern of knots at the endpoints of the mesh openings, provide rough, bumpy, and unstable surfaces on which printing is not easily performed.

A need therefore exists for a method and device that can allow textual and/or graphical messages to be imprinted into or onto the protective net itself. Such a system would provide a viable solution to the problems of providing adequate protection and augmenting revenues from advertising.

### BRIEF SUMMARY OF THE INVENTION

Accordingly, the present invention is directed toward a system (method, apparatus, and use) that allows protective nets to be imprinted with one or multicolor graphics and text, on one or both sides of said nets. The nets can typically comprise a plurality of nylon and polynylon mesh netting combinations that can be imprinted with digital printing, screen printing, air brush painting, roller painting, airless spray painting, aerosol spray painting, dyeing, and other methods. Nets made accordingly, referred to hereinafter for the sake of brevity as Sports Advertising Nets (“SAN's”), have the ability to be raised and lowered, stretched or tensioned, and have wind-spilling features.

SAN's are typically manufactured so that the front and back surfaces have the same, or nearly the same, surface area, and can be positioned to lay flat to provide a natural printing surface. SAN's are manufactured in a plurality of sizes, shapes, and colors, and all have see-through visibility, long service life, and will not corrode, peel, or mildew. A variety of pre-engineered attachment structures are available so that the SAN's easily can satisfy the installment criteria of the venue. SAN's can be custom-manufactured to exact size, weight, color, shape, and impact specifications, and can be fitted with reinforcing edges for increased strength and simplified installation.

Because of the plurality of mesh sizes possible, SAN's can be used in virtually all locations where nets are useful, including, for example, high traffic areas (such as ticket windows) and areas where unwanted small animals (such as birds) are not desired, yet still providing a visual text or graphic message. SAN's provide both the protective features of standard netting, while at the same time are capable of multiple text or graphics messages on one or both sides—all without the need for any appurtenance whatsoever (electricity, additional frames, back panels, gaskets, etc.). SAN's utilize only the current venue's light sources and can still provide its advertising message, all without obstructing the view through the net.

As can be seen, it is an object of the present invention to provide a net that can display various messages on one or both sides without the need for any physical or electrical appurtenance.

A further object of this invention is to provide a net that can be used in locations where standard nets are used, while having the additional ability to display messages on one or both sides.

Another object of this invention is to provide a net that can display text or graphical messages on one or both sides without obstructing the view through the net.

Yet another object of this invention is to provide a net that can be used in sports arenas that provides appropriate protection while also providing space for text, graphical, and/or advertising messages.

A further object of this invention is to provide a net that has messages on both sides thereof, wherein neither message interferes with or obstructs the view of the other message.

An additional object of this invention is to provide a method of imprinting or affixing text and/or graphical messages to one or both sides of a net of any shape, size, and color.

Yet another object of this invention is to provide an easily deployable, effective means for providing advertising space on nets.

These and other objects of the present invention not explicitly stated will be set forth and will be more clearly understood in conjunction with the description of the preferred embodiment disclosed hereinafter.

### DESCRIPTION OF THE DRAWINGS

The teachings of the present invention can be readily understood by considering the following detailed description in conjunction with the accompanying drawings, in which:

FIG. 1 is a color photocopy of a photograph of an elevation view of a net according to the present invention wherein the net comprises on one side thereof an advertising symbol that is a registered trademark of Adidas, Inc.;

FIG. 2 is a color photocopy of a photograph of an elevation view of a net according to the present invention wherein the net comprises on one side thereof an advertising symbol that is a registered trademark of Nike, Inc.; and

FIG. 3 is a color photocopy of a photograph of a perspective view of the nets of FIGS. 1 and 2.

FIGS. 4, 5, 6 and 7 depicts the subject matter of the invention wherein the net is affixed upon the coated platen surface.

FIG. 8 depicts a mask that defines the area of the net that will receive a coating of printing medium. For simplicity, this Fig. Does not depict the net, jig elements or frisket that would be on the platen.

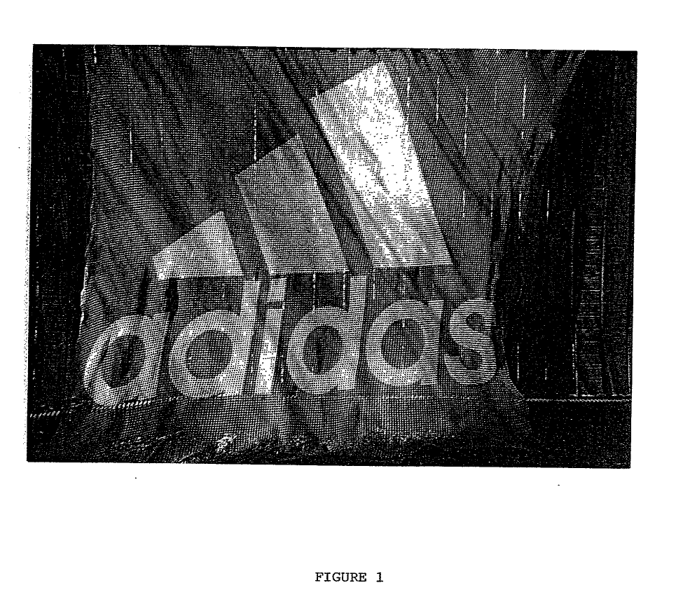

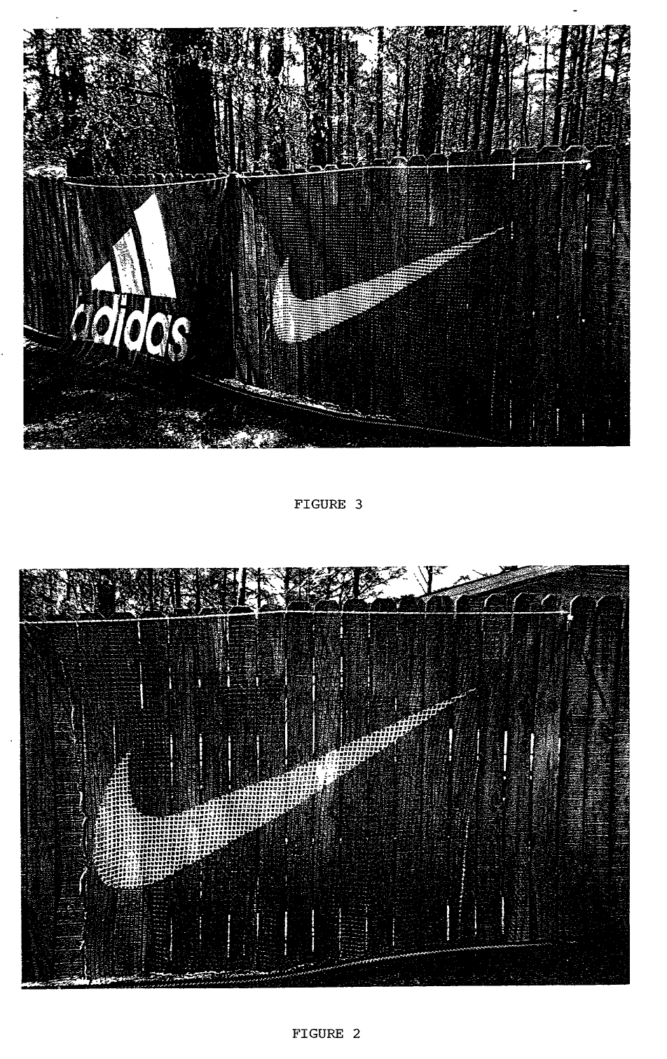

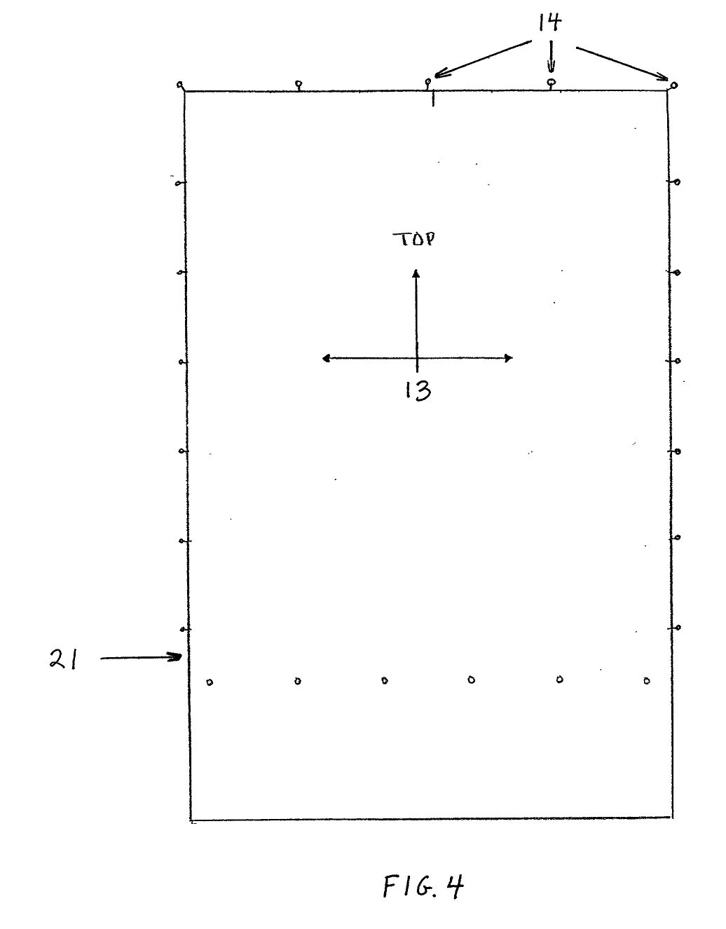

### DETAILED DESCRIPTION OF THE INVENTION

While the present invention will be described more fully hereinafter with reference to the accompanying drawings, in which particular embodiments and methods of fabrication are shown, it is to be understood from the outset that persons of ordinary skill in the art may modify the invention herein described while achieving the functions and results of this invention. Accordingly, the descriptions which follow are to be understood as illustrative and exemplary of specific embodiments within the broad scope of the present invention and not as limiting the scope of the invention. In the following descriptions, like numbers refer to similar features or like elements throughout.

As stated above, the uses and locations in which SAN's can be installed for protection and advertising are many. SAN's are primarily useful as an advertising medium onsite, as well as during electronic media broadcasts. As stated, one of the main features of SAN's is that no additional items, structures, appurtenances, etc., are needed in order to display a message. SAN's perform the same functions as nets currently in use, such as providing protection and loss prevention during sports events (including, but not limited to, all levels of competition in baseball, softball, football, soccer, rugby, field hockey, lacrosse, etc.), while also providing a method for displaying messages that can generate advertising revenues. In addition, SAN's can be used in non-athletic functions, as stated above. Furthermore, SAN's can be used for any of the equipment and facilities associated with the various sports. For instance, football kicking cages, baseball batting cages, golf driving ranges, golf chipping/driving nets, etc. Also, SAN's can be used on and around the support equipment most often seen at electronic media interviews during pre-game activities. Additional baseball examples include fencing, bullpen areas, backstops, etc. In lacrosse, soccer, and hockey, SAN's can be used to contain the ball or puck, and to prevent spectators from becoming inadvertently involved in the action. In industrial applications, SAN's can be used to contain cargo, to separate or segregate areas, to protect workers from hazardous areas, etc. Any application where nets are needed could be an opportunity to retro-fit with SAN's. In all these applications, and the many others not specifically enumerated, the SAN's perform all the functions of standard nets, while also providing effective advertising space and while not obstructing the view through the SAN's from either side of the SAN's.

The first step in creating the desired SAN is to choose the net. The nets can be manufactured from a variety of materials, including cotton, cotton blends, nylon, nylon blends, as well as any fibrous product that can be woven. However, nylon or polynylon woven mesh nets are preferred because of their adequate strength, minimum light blockage, and ability to provide a flat surface onto which coatings may be applied or imprinted. Nets can be manufactured having various mesh sizes and shapes, depending on the application and the strength needed. Some standard square mesh sizes range from ⅛″ mesh to 4″ mesh, in increments of ⅛. Again, however, it is to be understood that hundreds of different size/shape combinations are possible.

The preferred nets (of whatever size appropriate for the installation and use) are mesh nets, otherwise known non-cord-type nets, and can be obtained from many net manufacturers, including, for example, Sterling Net & Twine Company, Inc. Cord-type can be used, but are not preferred. Mesh nets are better suited to laying flat so as to accommodate many types of printing and finishing procedures that create the desired graphics, to be discussed below.

Once the type of net has been selected, the net is then cut to the appropriate size and shape required for the installation. For instance, nets for use in many sports venues will be rectangular in shape. The net is then prepared for installation according to the engineering requirements of the venue. For example, some nets may require structural reinforcements or hangers along one or more edges or at one or more corners. Other nets may require attachment of mechanisms and structures that will allow the net to be slidably received by a structure at the venue (e.g., a pole). The SAN is engineered so that attachment and installation at the desired venue can be by various means, including, but not limited to, the following: ties, hangers, straps, brackets, braces, jigs, hook and loop fasteners, and zippers. In addition, the SAN's can be draped over an object, stretched between objects, and folded. At this stage, the nets are, in short, prepared for final assembly by installing or affixing whatever is required by the venue in which the net will be used.

After the net has been selected, it may need to be cut to the appropriate shape and size and prepared for assembly, with attachment means, then the desired text or graphical message is to be applied to one or both sides of the net. Various techniques can be employed to apply that text or graphic, and for the sake of brevity, all techniques will be discussed as though they employ an “imprinting” of the message on the net.

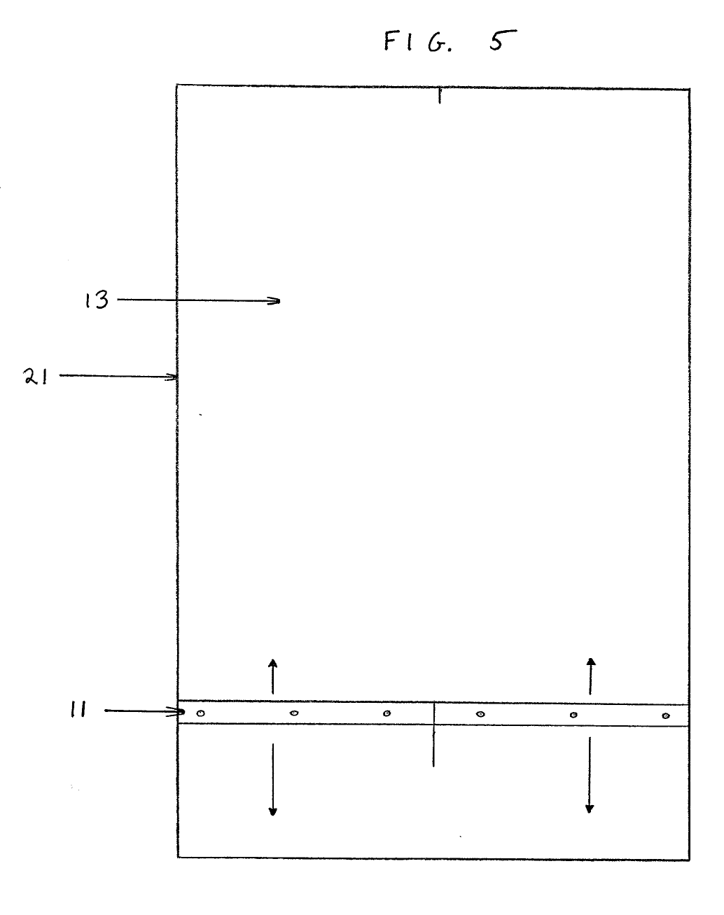

Most of the techniques for imprinting employ some form of platen structure that secures the net during the operation, for both safety and quality control reasons. In one embodiment, FIGS. 4 and 5, the platen 21 is made of wood and on a platform. On two or more edges of the platen, are jig elements, such as hooks or shoulder eye bolts 14 that are reasonable. These elements serve to hold the net on the platen. This embodiment also has an adjustment clamp or bar that can be affixed to the platen surface by hardware. The clamp or bar can be adjustable so as to be moved to different locations on the platen surface. The bar can be used to provide additional stability to the net, alongside the area of the net on which the printing medium will be applied. The platen structure provides stability to the net, and provides a printing surface. It usually includes a surface area that can accommodate various sizes, shapes, and types of nets. Three general methods of preparing the platen for the net are used preferably.

In the preferred method, the platen surface 13 is coated or lined with paraffin preferably, (or any other similar hydrocarbon substance, including those that are semisolid and those that are more liquid or oily). One side of the net will be placed against the paraffin coated platen. These paraffin substances prohibit or impede the imprinting materials applied to one side of the net from flowing or otherwise moving to the opposite side of the net. The paraffin is available in sheets in varying widths of numerous lengths (for example, 2 feet and 4 feet widths in rolls of varying length). The appropriate size paraffin sheet is cut and rolled onto the platen. Methods of affixing the paraffin to the platen vary, but a preferred method is to utilize an industrial adhesive tape, not unlike duct tape. Once the paraffin or similar product is placed on the platen, the net is put into place by securing it to the platen or other structure, typically using an adjustable jig that stretches the net over a given area. The jig usually attaches to the platen via hooks, clips, etc. Preferably, all sides of the net are drawn equally tight so that the net is taut. The net is then pressed into, or embedded in the paraffin using a heavy roller or press plate. The coating holds the net stable on the platen, it masks to one side of the net, and enables the net to be imprinted on the other side.

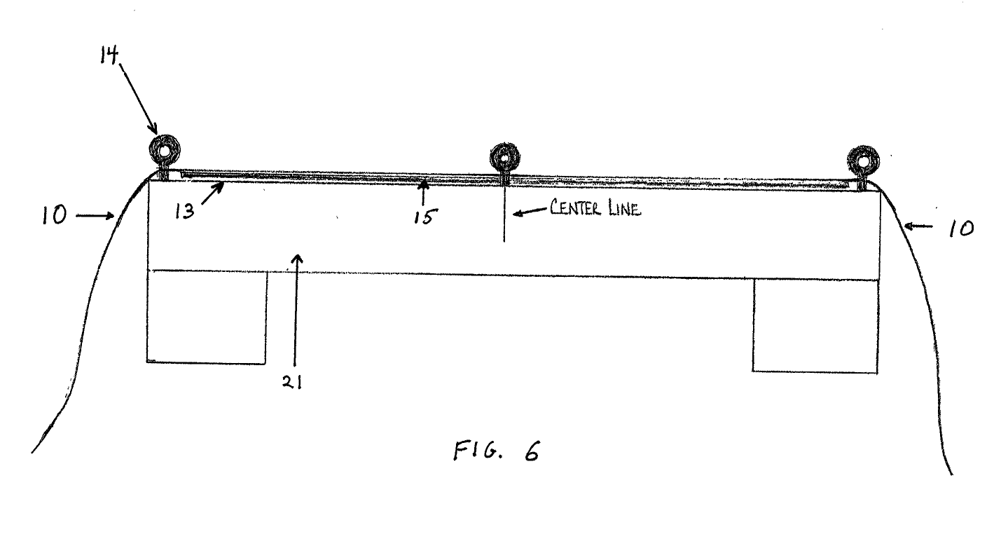

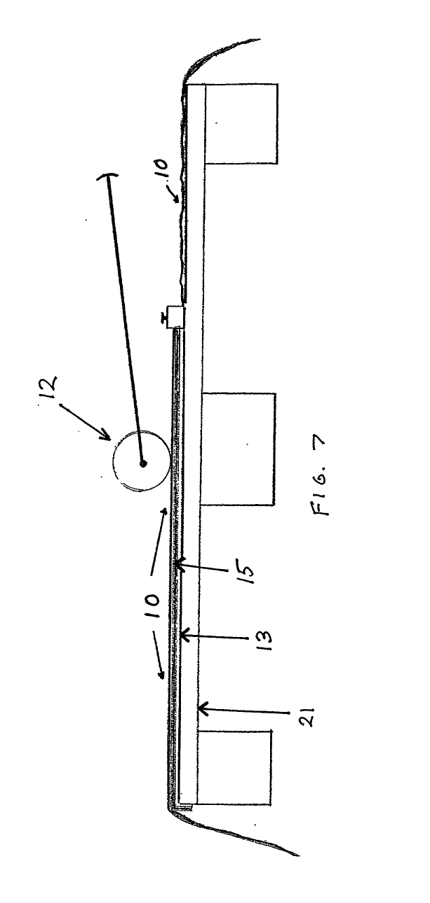

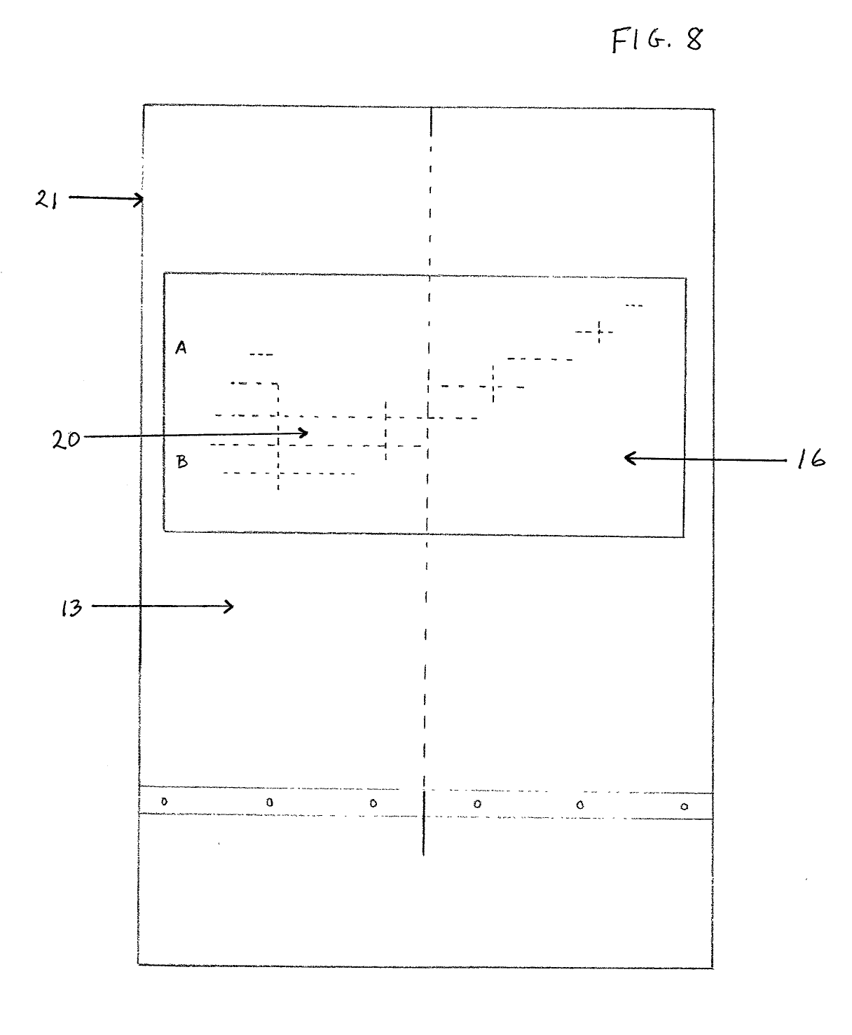

As depicted in FIGS. 6 and 7, the net 10 is affixed to the platen 21 using jig elements 14 and adjusted generally taut. The platen surface 13 has a frisketing material 15 on it such as paraffin or polymask. One side of the net 10 is pressed against the frisket 15 upon platen surface 13. In one embodiment, the area of the net that will be printed on has a heavy roller run across it to embed the back side of the net into the paraffin, or to firmly adhere that side of the net to the polymask. In FIG. 8, a mask 16 of removable masking material which defines the area 20 on the front side of the net to which the imprinting medium, will be applied to the front side, and the back side of the net which is not to be imprinted is masked by the frisket 15. In another embodiment, the back side of the net receives no printing medium, due to the frisket, and a predetermined area of the front side receives the printed graphic display by means of imprinting methods hereinafter listed which does not require masking part of the front side.

In another method, the platen is covered with polyethylene, polypropylene, or other type plastic sheet. The net is placed and stretched on the plastic-coated platen. Molten paraffin or other wax is then rolled onto the top surface of the net to mask over the areas that are desired not to be imprinted. This obviously depends on the desired design, but this method allows much greater graphical detail for the SAN's. This method is similar to the Indonesian art of batik, sometimes called java print. In short, it is a method of dyeing a net by which the parts of the net not intended to be dyed are covered with removable wax.

A third method of preparing the net for imprinting is the use of a substance known as “polymask” manufactured by 3M. This also comes in rolls, and is a plastic-type material having an adhesive on one side. The polymask is placed on the platen, with the adhesive side facing upwards. The net is then placed, and preferably rolled, onto the polymask such that the net mesh adheres closely to the plastic sheeting. The top side of the net then is ready for imprinting, by any of the various methods described here, including methods not unlike stenciling.

The net, which is now the printing area, is then embedded or pressed onto the platen, and therefore into the paraffin or similar impressible product. In the second example, the polymask adheres to and so masks the back side of the net. This is best accomplished using heavy rollers or a press device well known in the art. Once the net is so positioned, the platen and paraffin substance act as a frisket to ensure net stability during printing, while protecting the opposite net side from the application of the text/graphic materials. Once the net is in place, the choice of printing techniques will be determined, in part, by the size, shape, and complexity of the message (text and/or graphics) to be applied to the net.

Various methods or techniques are available for creating the desired message on the face of the net. These imprinting techniques include, but are not limited to, the following:

Custom dyeing colors using the Pantone Matching System (PMS), or other industry color matching systems (both before and after the manufacturing of the net substrate)

Custom dyeing with resistance (for example, as discussed above using techniques similar to batik, wax or other formula or products)

Dye sublimation transfers (including those of a wet/dry or gaseous nature)

Discharge or bleaching techniques

Digital printing (inkjet, laser, wax thermal, dye sublimation, bubblejet, and drum printers)

Manual handheld devices (including air and gas propelled, roller, brush, press, sputter) with or without the use of stencils

Screen printing processes and products (using plastisols, enamels, ultraviolet cured latex bases, solvents, evaporative inks, discharge inks (including all water-based and solvent-based inks), and printing products)

Mechanical processes using computer-automated systems (X-Y and other linear motion devices) for large scale units that require detailed printing, high resolution and high production. A press system that accommodates preprinted sublimation or heat transfer products could also be retro-fitted into the printing process.

In addition, weaved or embroidered techniques could be obtained through custom order.

After the appropriate imprinting technique has been used, sufficient drying is desired. Drying techniques may vary depending on the materials used in the application as well as the techniques used. Possible drying techniques include forced air, ultraviolet light, heat lamps, convection ovens, and roller heated ovens, in addition to simple air drying. After sufficient drying, if desired, the opposite side can be imprinted with the same or a different message using the same or different techniques.

The end product is a SAN that can be used wherever nets are used, but which includes one or more messages on one or both sides of the net. This provides an extremely valuable opportunity for advertising and raising revenue thereby. Use of the method and apparatus disclosed here can be used to apply an imprint to the front side of the net and no imprint on the back side, as well as to imprint on both sides of the net.

While there has been described and illustrated particular embodiments of a SAN for effectively conveying one or more messages on one of both sides of a net, it will be apparent to those skilled in the art that variations and modifications are possible without deviating from the broad spirit and principle of the present invention, which shall be limited solely by the scope of the claims appended hereto.

1. A displaying means comprising:
a net, said net having a frontward and a rearward side, said frontward side having a predetermined area for receiving a printing medium, and a coating of printing medium applied only to said predetermined area.

2. A sports advertising net, which comprises:
(a) a mesh net with a front side and a back side;
(b) a coating of printing medium applied to an area of said front side of said mesh by impressing said back side to a frisket on a platen surface and applying said imprinting medium to said area of said front side of said mesh net.

3. A sports advertising net, according to claim 2, wherein said coating of imprinting medium is applied by either digital printing, silk screen, air brush printing, roller painting, spray painting, dyeing or stenciling.

4. A sports advertising net, which comprises:
(a) a mesh net with a front side and a back side;
(b) a coating of imprinting medium applied to an area of said front side of said mesh by impressing said net to a frisket on a platen surface, and imprinting upon an area of said front side by applying a printing medium.

5. A sports advertising net, which comprises:
(a) a mesh net with a front side and a back side;
(b) a coating of imprinting medium applied to an area of said front side of said mesh by impressing said back side to a frisket on a platen surface, and masking an area of said front side, such that said imprinting medium is applied only to the unmasked area of said mesh net.

6. A sports advertising net, which comprises:
(a) a mesh net with a front side and a back side;
(b) a coating of imprinting medium applied to a predetermined area of said front side of said mesh by impressing said back side to a frisket on a platen surface, and applying a printing medium to said predetermined area.

7. A sports advertising net according to claim 6, wherein said predetrmined area is delineated by a mask applied to said front side before said printing medium is applied.

8. A sports advertising net prepared by a process comprising the steps of
(a) applying a frisket to a platen surface;
(b) affixing a net upon said frisketed platen surface;
(c) imprinting upon an area of said net by applying a printing medium; and
(d) removing said net from said frisketed platen surface.

9. A sports advertising net prepared by a process comprising the steps of
(a) applying a frisket to a platen surface;
(b) affixing a net to said frisketed platen surface;
(c) masking an area of said net;
(d) imprinting upon the areas not masked by applying a printing medium; and
(e) removing said masking, and removing said net from said frisketed platen surface.

10. A method of imprinting a sports advertising net comprising the steps of;
(a) impressing one side of a net to a platen surface coated with a frisket, and
(b) imprinting on the opposite side of said net.

11. A method according to claim 9, which further comprises:
drying said imprinting medium applied to said net.

12. A method according to claim 10 which further comprises:
masking an area on said opposite side of said net before imprinting upon said opposite side.
